(19) United States
(12) Patent Application Publication
(10) Pub. No.: US 2026/0222738 A1
(43) Pub. Date: Jul. 30, 2026

(54) THREE-DIMENSIONAL MICROPHONE ARRAY FOR SOUND ACQUISITION AND SOUND PICKUP DEVICE

(71) Applicant: YEALINK (XIAMEN) NETWORK TECHNOLOGY CO., LTD., Xiamen (CN)

(72) Inventors: Wanjian Feng, Xiamen (CN); Lifeng Lin, Xiamen (CN)

(21) Appl. No.: 19/457,267

(22) Filed: Jan. 23, 2026

(30) Foreign Application Priority Data
Jan. 24, 2025 (CN) 202510116543.8

(51) Int. Cl. H04R 5/027

(52) U.S. Cl. CPC H04R 5/027

(57) ABSTRACT

The disclosure provides a three-dimensional microphone array for sound acquisition. The microphone array comprises a plurality of sub-microphone arrays for sound pickup, each comprising a plurality of microphones disposed on the front surface of the substrate; Herein, orthogonal projections of the plurality of microphones of each of the sub-microphone arrays onto a horizontal plane are distributed along a ray, and the ray, on which the orthogonal projections of each of the sub-microphone arrays lie, originates from a center of an orthogonal projection of the substrate onto the horizontal plane and extends to an edge of the substrate; Herein, the front surface of the substrate has a non-planar shape.

### CROSS-REFERENCE TO PRIOR APPLICATION

This application claims the benefit of the priority of Chinese Patent Application No. 202510116543.8 filed on January 24, 2025, the contents of which are incorporated herein by reference.

### TECHNICAL FIELD

The disclosure relates generally to the technical field of microphone arrays, more particularly to a topological arrangement of microphones in space.

### BACKGROUND

The microphone array plays a very important role in video conferences. The microphones need to capture clean sound signals of participants’ speeches, to enable accurate transmission of the sound signals to other attendees. During conferences, in order to minimize confusion and mutual interference among the sounds, it is essential for the microphones to differentiate distinct sound sources and collect each person’s voice as clearly as possible. For example, when speakers talk simultaneously, the microphones should pick up sounds from different directions, to support the clear transmission of voices from all directions.

Various configurations of microphone arrays are known. For example, one-dimensional arrays, such as uniform linear arrays, are employed for directional sound pickup in a horizontal plane. Two- dimensional arrays, such as circular or planar arrays, can provide information for estimating the direction of a sound source in both azimuth and elevation.

In applications such as teleconferencing and acoustic monitoring, it is generally desirable for a sound pickup system to capture clear audio from different locations within an environment.

### SUMMARY

The disclosure is to provide a three-dimensional microphone array for sound acquisition and a sound pickup device. The three-dimensional microphone array is composed of a plurality of sub-microphone arrays that are not in the same plane, to address the problems of conventional one-dimensional and two-dimensional microphone arrays being unable to capture the voices of speakers from various directions and accurately locate the heights of the speakers’ voices, and significantly enhance the quality of sound acquisition and the capability of sound source localization in space.

In some embodiments, the disclosure provides a three-dimensional microphone array for sound acquisition. The microphone array comprises: a substrate having a front surface and a rear surface; and a plurality of sub-microphone arrays for sound pickup. Each of the sub-microphone arrays comprises a plurality of microphones disposed on the front surface of the substrate. Herein, orthogonal projections of the plurality of microphones of each of the sub-microphone arrays onto a horizontal plane are distributed along a ray, and the ray, on which the orthogonal projections of each of the sub-microphone arrays lie, originates from a center of an orthogonal projection of the substrate onto the horizontal plane and extends to an edge of the substrate. Herein, the front surface of the substrate has a non-planar shape.

In some embodiments, the plurality of microphones in the sub-microphone arrays may be not coplanar.

In some embodiments, the plurality of microphones in the sub-microphone arrays may be coplanar.

In some embodiments, at least one circularly arranged sub-microphone array is further disposed at a center of the substrate, and a center of the circularly arranged sub-microphone array may coincide with the center of the substrate.

In some embodiments, a straight line, on which orthogonal projections of each of the sub-microphone arrays lie, may originate from the circularly arranged sub-microphone array that is farthest from the center of the substrate, and extend to an edge of the substrate.

In some embodiments, the non-planar shape of the front surface of the substrate may be wavy shape, and the front surface that has the wavy shape may have a plurality of protruding areas arranged in sequence along a first direction (the protruding areas being distributed along a straight line or a circle).

In some embodiments, the plurality of microphones in the sub-microphone arrays may be disposed in sequence along peaks and troughs of the front surface that has the wavy shape.

In some embodiments, the plurality of microphones of the sub-microphone arrays may be disposed in sequence along sloping surfaces of the front surface that has the wavy shape.

In some embodiments, a center of the substrate may be higher than the edge of the substrate.

In some embodiments, the substrate may be composed of a plurality of sub-substrates pieced together.

In some embodiments, the substrate may be formed by a plurality of sector-shaped sub-substrates pieced together.

In some embodiments, the microphones in the sub-microphone arrays may be arranged in a same way.

In some embodiments, the disclosure further provides a sound pickup device, which comprises at least: the abovementioned three-dimensional microphone array for sound acquisition.

### BRIEF DESCRIPTION OF THE DRAWINGS

FIG. 1 is a schematic view illustrating an application scenario of a three-dimensional microphone array for sound acquisition according to some embodiments of the disclosure.

FIG. 2A is a schematic perspective view of a three-dimensional microphone array for sound acquisition according to some embodiments of the disclosure.

FIG. 2B is a schematic top view of a three-dimensional microphone array for sound acquisition according to some embodiments of the disclosure.

FIG. 2C is a cross-sectional view at line A-A of FIG. 2B according to some embodiments of the disclosure.

FIG. 2D is a cross-sectional view at line A-A of FIG. 2B according to some further embodiments of the disclosure.

FIG. 2E is a cross-sectional view at line A-A of FIG. 2B according to some further embodiments of the disclosure.

FIG. 2F is a cross-sectional view at line A-A of FIG. 2B according to some further embodiments of the disclosure.

FIG. 2G is a cross-sectional view at line A-A of FIG. 2B according to some further embodiments of the disclosure.

FIG. 3 is a schematic top view of a three-dimensional microphone array for sound acquisition according to some further embodiments of the disclosure.

FIG. 4 is a schematic top view of a three-dimensional microphone array for sound acquisition according to some further embodiments of the disclosure.

FIG. 5 is a schematic view of a substrate of a three-dimensional microphone array for sound acquisition according to some embodiments of the disclosure.

### DETAILED DESCRIPTION OF ILLUSTRATED EMBODIMENTS

Some of the terms used in this application are described below.

The arrayed microphones refer to a microphone system composed of plurality of microphones (acoustic sensors) arranged according to some rules and used as a sound pickup device for acquisition and processing of spatial characteristics of a sound field.

The microphone refers to an acoustic sensor, which is a transducer that converts sound signals into electrical signals. It achieves the conversion from sound to electrical signals mainly according to the principles such as electromagnetic induction, capacitance changes, piezoelectric effects, etc. There are types of microphones, including dynamic microphones, condenser microphones, electromagnetic microphones, and piezoelectric microphones.

### Further terms

In the embodiments of the disclosure, the term “exemplary” or “example” or the like means serving as an example, illustration, or explanation. Any embodiment or solution described as “exemplary” or “example” in the embodiments of the disclosure should not be construed as being more preferred or advantageous over other embodiments or solutions. Rather, the use of the terms “exemplary” or “example” or the like is intended to present relevant concepts in a concrete manner.

In the embodiments of the disclosure, the terms “first” and “second” are used for illustration and are not intended to indicate or imply relative importance or hint the quantity of features. Consequently, features defined by the terms “first” and “second” are intended to indicate or hint one or more of such features.

Unless explicitly stated otherwise, “plurality of” as used herein refers to two or more. In the description, the term “at least one” refers to one or more, and the term “plurality of” refers to two or more.

It should be understood that the terms “an embodiment”, “one embodiment”, and “a possible embodiment” used in the specification refer to specific features, structures, or characteristics related to embodiments or implementations that are included in at least one embodiment of the present application. Therefore, the terms “in an embodiment”, “in one embodiment”, and “in a possible embodiment” mentioned throughout the specification do not necessarily refer to the same embodiment. Furthermore, these specific features, structures, or characteristics may be combined in one or more embodiments in any appropriate manner.

The technical solutions according to embodiments of the disclosure will be clearly and completely explained below in detail with reference to the accompanying drawings of the embodiments of the disclosure. Apparently, the described embodiments are merely a part rather than all of the embodiments of the present disclosure. All other embodiments obtained by those skilled in the art based on the embodiments of the present disclosure without creative efforts shall fall within the scope of the present disclosure.

The existing technical solutions typically employ one-dimensional or two-dimensional microphone arrays in conjunction with Direction of Arrival (DOA) and Array Beamforming (BF) algorithms for sound localization and acquisition. Conventional microphone array topologies include Uniform Linear Array (ULA), circular array, spiral array, cross array, rectangular array, etc. Among these, the one-dimensional arrays, which are simple in structure, low in cost, and easy to deploy, can enable horizontal localization and directional sound pickup. They are commonly applied on devices, such as all-in-one video conferencing systems and large conference tablets, that are deployed at the front of meeting rooms. Compared to the one-dimensional arrays, the two-dimensional arrays can capture richer information about the sound source’s location. They can achieve 360-degree beam pointing and two-dimensional direction of arrival and are often used in applications such as smart speakers, ceiling microphones, and acoustic imaging. Among the microphones in the aforementioned array topologies, the one-dimensional arrays can only receive limited spatiotemporal information and localize the azimuth angle in the horizontal direction, but cannot obtain information about the sound source’s elevation angle. The two-dimensional microphone arrays that enable the calculation of elevation angle can improve the deficiency of the one-dimensional arrays that only provide the sound source’s azimuth angle. However, they cannot determine the distance from the sound source to the microphones. Furthermore, as the elevation angle of the sound source increases, the sidelobes of the beam in a planar array may deteriorate. It not only may lead to deviations in the accuracy and resolution of direction of arrival at different elevation angles, but also may result in a change of the clarity and frequency response consistency of the beam’s sound pickup. Consequently, the topological structures of existing microphone arrays cannot clearly capture the voices of speakers from all directions in multi-person discussion scenarios.

To this end, a microphone array that can improve the quality of sound acquisition and the capability of direction of arrival in space is desired.

The disclosure provides a three-dimensional microphone array for sound acquisition and a sound pickup device. The three-dimensional microphone array is composed of plurality of sub-microphone arrays that are not in the same plane, to address the problems of conventional one-dimensional and two-dimensional microphone arrays being unable to capture the voices of speakers from various directions and accurately locate the heights of the speakers’ voices, and significantly enhance the quality of sound acquisition and the capability of direction of arrival in space.

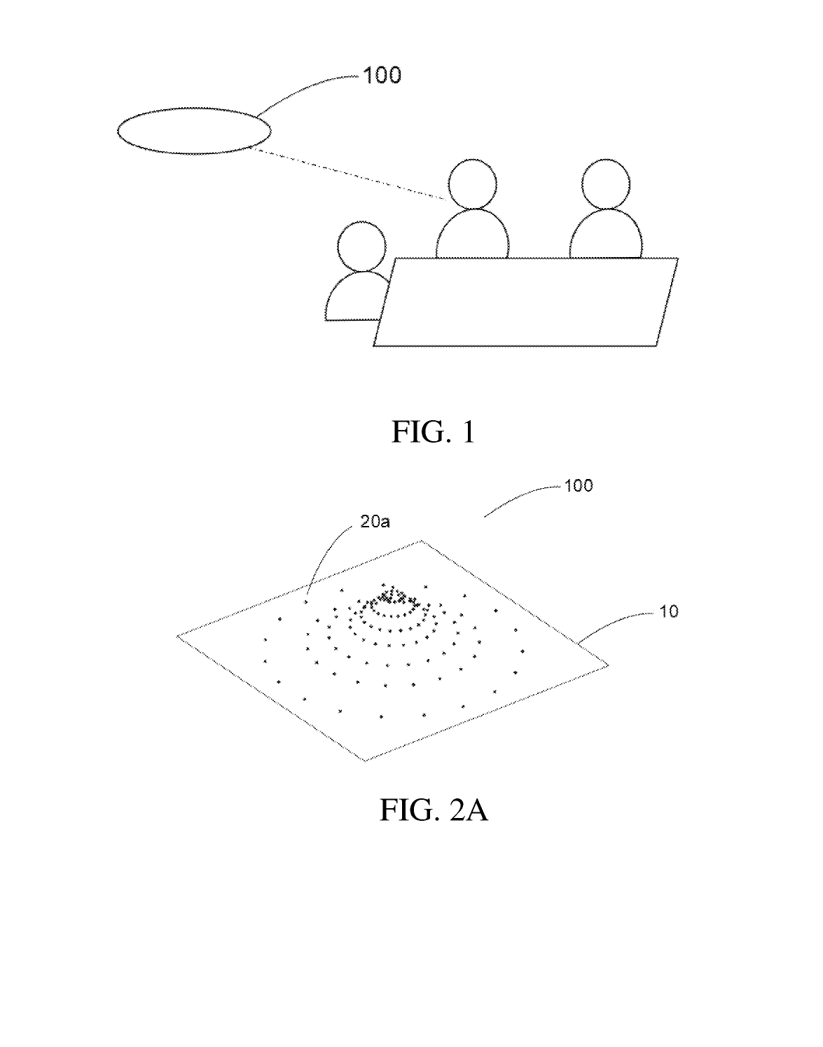

Refer to FIG. 1 which shows an application scenario of a three-dimensional microphone array 100 for sound acquisition. The three-dimensional microphone array 100 is typically used in conference rooms with video conferencing functionality. The three-dimensional microphone array 100 may be placed in various locations, for example, at the center of a table, in front of the speakers, on the edge of a conference room podium, or on the ceiling. In some embodiments, the three-dimensional microphone array 100 is generally installed on the ceiling of a conference facility such as a conference room. Its relatively high position allows it to cover a larger area and fully capture the voices of speakers from all directions in the conference room. Thus, it can avoid the situations where sound acquisition is poor in certain areas due to the limited placement of microphones. Exactly because of the unique installation position, strong three-dimensional spatial direction of arrival capabilities of the three-dimensional microphone array 100 are required, to capture clear voices of speakers from all directions, to ensure that the voices of participants can be well picked up regardless of their movements or position changes within the conference room, and to maintain the stability and uniformity of sound acquisition.

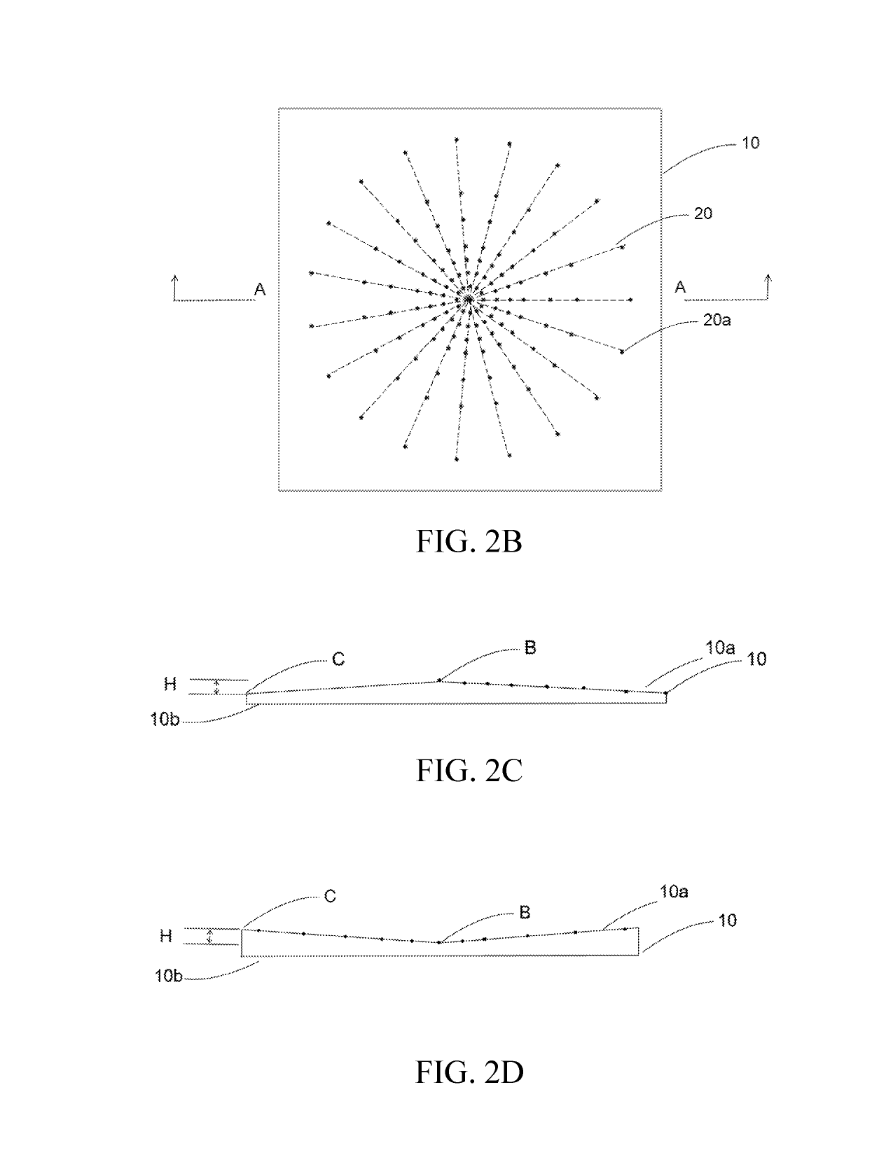

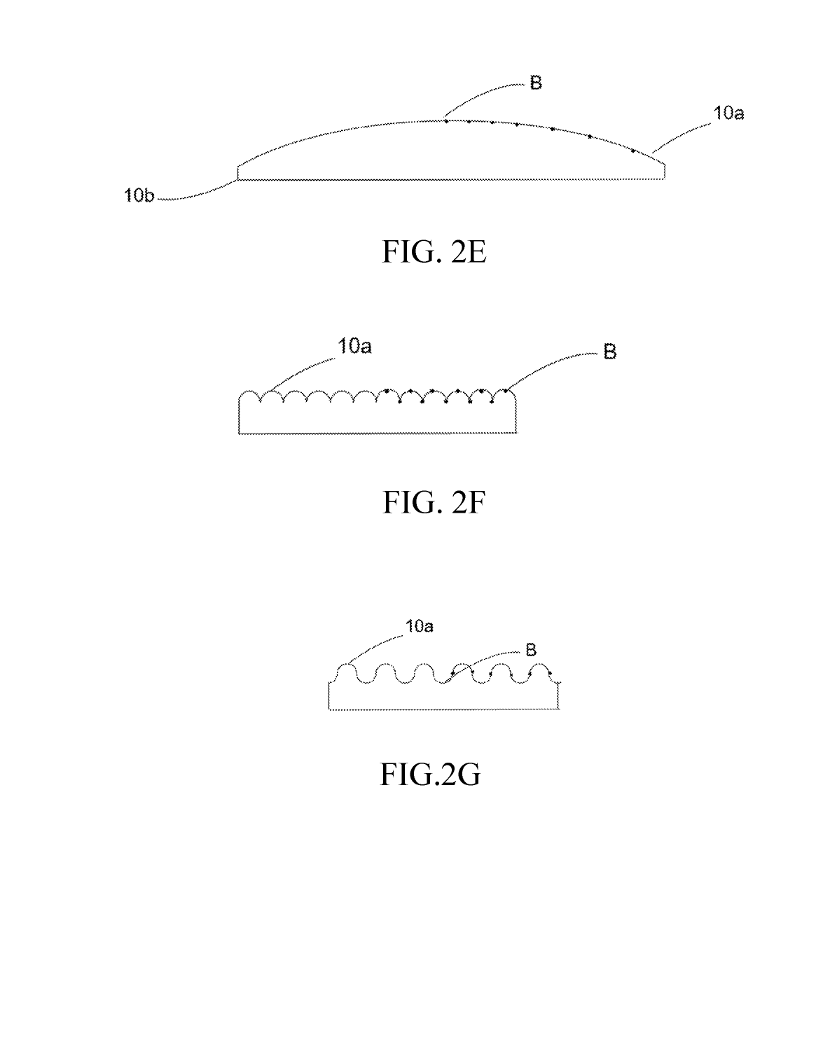

Refer to FIGS. 2A-2C which respectively show a perspective view, a top view, and a cross-sectional view of the three-dimensional microphone array 100 for sound acquisition according to some embodiments of the disclosure. In the embodiment, the three-dimensional microphone array 100 comprises a substrate 10 having a front surface 10a and a rear surface 10b, and plurality of sub-microphone arrays 20 for sound pickup, wherein each of the sub-microphone arrays comprises plurality of microphones 20a, and plurality of microphones are disposed on the front surface 10a of the substrate 10. The orthogonal projections of the plurality of microphones 20a of each of the sub-microphone arrays 20 onto the horizontal plane are distributed along a ray, and the ray, on which the orthogonal projections of each of the sub-microphone arrays 20 lie, originates from the center B of the orthogonal projection of the substrate onto the horizontal plane and extends to the edge of the substrate. The front surface 10a of the substrate has a non-planar shape. For example, the center of the front surface 10a of the substrate in the embodiment may be slightly higher than the edges of the substrate. As shown FIGS. 2C-2D, a height difference H may be defined between the center B of the substrate and the edge C of the front surface of the substrate. The height difference H may be approximately 3mm-3cm. Since each of the sub-microphone arrays 20 includes plurality of microphones 20a and the microphones 20a in the same sub-microphone array 20 have height differences therebetween, at least two or more of the sub-microphone arrays are spatially not in the same plane, thereby forming a three-dimensional sound acquisition system. It can improve the elevation directionality of the microphone arrays, enable higher positioning accuracy at long-distance orientations, and thus significantly enhance the direction of arrival capability in three-dimensional space, and render it suitable for use in three-dimensional space.

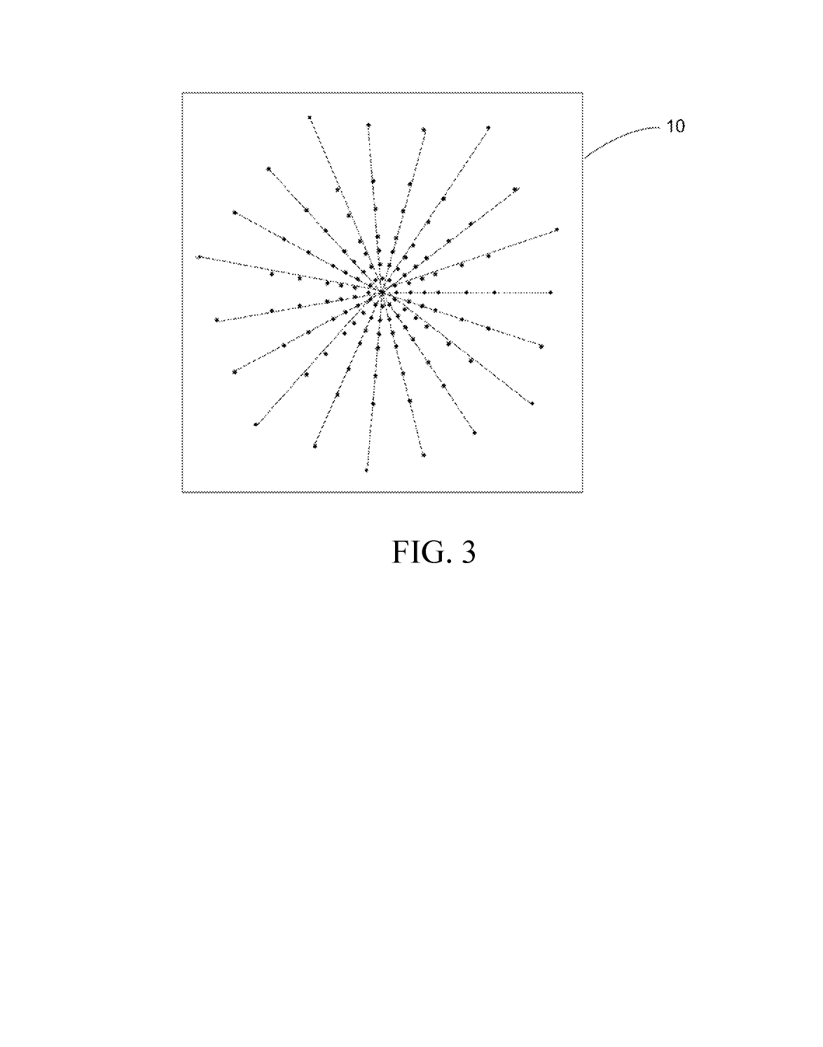

In some embodiments, the plurality of microphones 20a in each sub-microphone array 20 are coplanar. Besides, the plurality of microphones in each of the sub-microphone arrays may have height differences therebetween, and the microphones may be arranged in such a manner that the distances between adjacent microphones are either equal or increase from the inner side to the outer side. The arrangements of the microphones of each of the sub-microphone arrays may be the same or different. As shown in FIG. 2C, the distances between adjacent microphones increase from the inner side to the outer side. Taking the sub-microphone array 20 that includes 8 microphones as an example, the horizontal distances from each of the microphone arrays to the center B of the substrate may be respectively indicated by d1-d8 (not marked in the drawings), where d1＝0m, d2＝0.021m, d3＝0.044m, d4＝0.065m, d5＝0.090m, d6＝0.130m, d7＝0.170m, d8＝0.255m. Though the sub-microphone arrays 20 each including 8 microphones in the embodiment are described as an example, with regard to each of the sub-microphone arrays 20, the number of sub-microphone arrays and the number of microphones may be designed in practice based on the parameter properties, such as the white noise gain or the directivity, of the three-dimensional microphone array. As shown in FIG. 3, the sub-microphone arrays 20 each have different arrangements of microphones. For example, the distances between the microphones of at least one of the sub-microphone arrays 20 may be different from the distances between the microphones of the adjacent one of the sub-microphone arrays.

In some embodiments, the plurality of microphones 20a in each of the sub-microphone arrays 20 are not coplanar. Since the substrate 10 has the non-planar shape, such as a wavy shape or a curved shape, the plurality of microphones 20a lie on different planes. As shown in FIGS. 2E-2G, the front surface 10a of the substrate has wavy shapes or curved shapes, and the plurality of microphones 20a in each of the sub-microphone arrays 20 are distributed on the non-planar shaped substrate 10 with the distances between adjacent microphones being equal or increasing from the inner side to the outer side. The microphones disposed on the uneven surface of the substrate can form a three-dimensional layout and provide three-dimensional information, and thus can enable three-dimensional 360-degree beamforming. The three-dimensional layout of the microphones can facilitate the direction of arrival capability to capture clear voices of speakers from various directions, ensure that the voices of participants can be well picked up regardless of their movements or position changes within the conference room, and maintain the stability and uniformity of sound acquisition.

In some embodiments, the non-planar shape of the front surface of the substrate is wavy shape, and the front surface that has the wavy shape is provided with a plurality of protruding areas arranged in sequence along a first direction. The protruding areas may be linearly or circularly distributed. As shown in FIG. 2F, the plurality of microphones of the sub-microphone arrays 20 are disposed in sequence along the peaks and troughs of the wavy shaped front surface. As shown in FIG. 2G, the plurality of microphones of the sub-microphone arrays 20 are disposed in sequence along the sloping surfaces of the wavy shaped front surface. Since the wavy shaped substrate is not flat, most of the microphones located thereon are not coplanar, thereby providing a three-dimensional microphone array with a low cost and breaking the planar limitation of conventional two-dimensional arrays. By providing microphones on the non-flat substrate, it realizes that the microphones are arranged on a plurality of planes at different heights, thereby achieving precise capturing of sound sources from all directions in three-dimensional space.

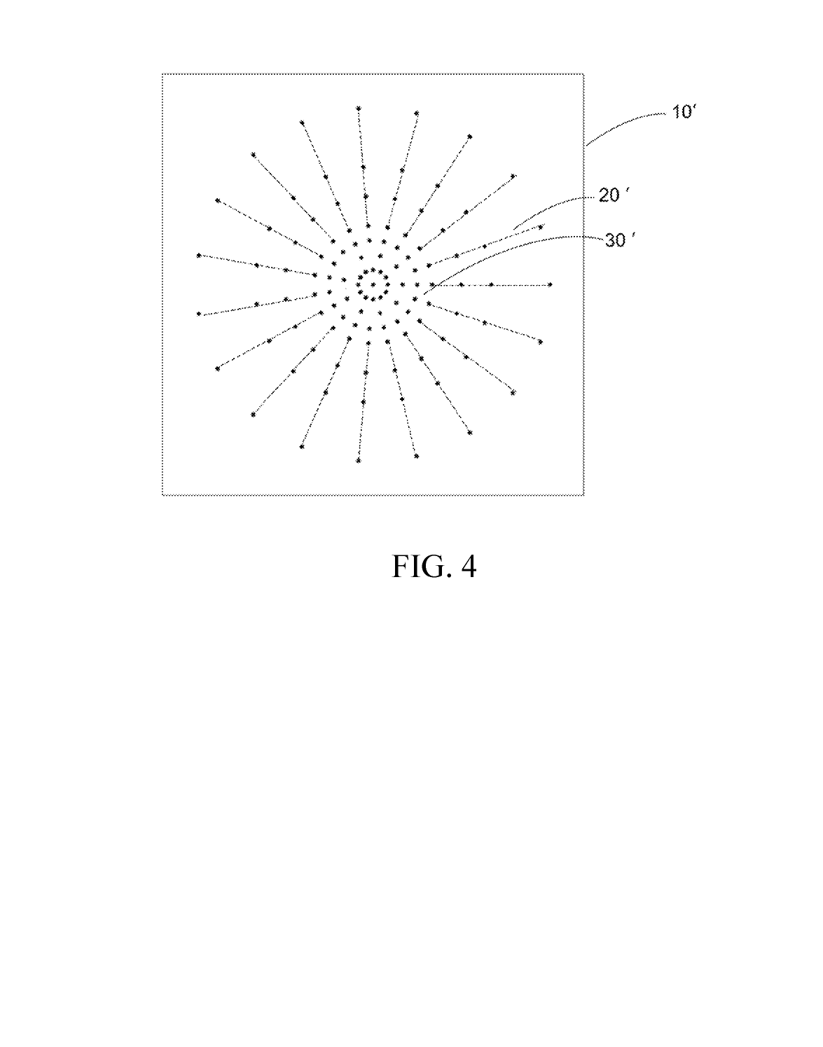

Referring to FIG. 4 which shows the three-dimensional microphone array 100 for sound acquisition according to some embodiments, the present embodiments are different from the previous embodiments in that at least one sub-microphone array 30', which is circularly arranged, is further disposed at the center of the substrate, and the center of the circularly arranged sub-microphone array 30' coincides with the center of the substrate. In the embodiment, take four rings of sub-microphones 30' as an example. With regard to the circularly arranged sub-microphone array 30', the number of sub-microphone arrays and the number of microphones may be designed in practice based on the parameter properties, such as the white noise gain or the directivity, of the three-dimensional microphone array. The straight line, on which the orthogonal projections of each of the sub-microphone arrays 20' lie, originates from the circularly arranged sub-microphone array 30' that is farthest from the center of the substrate, and extends to the edge of the substrate. The arrangements of the microphones in each of the sub- microphone arrays on the substrate may be different. As shown in FIG. 4, the fourth ring is farthest from the center of the substrate, and the straight lines of the sub-microphone arrays 20' originate from the microphones on the fourth ring and extend to the edges of the substrate. In addition, the number of the microphones in each of the circularly arranged sub-microphone arrays 30' may be the same or different. In the embodiment, the front surface of the substrate is non-flat. In other words, the front surface of the substrate may be wavy or curved, or a height difference H may be defined between the center B of the substrate and the edge C of the front surface of the substrate, such that the two types of microphones, i.e., the sub-microphone arrays 30' and sub-microphone arrays 20' are not coplanar. Thus, it can provide a three-dimensional layout of microphone arrays with a lower cost, and achieve precise capturing of sound sources from all directions in three-dimensional space. As the shape and number of sub-microphone arrays in the three-dimensional microphone array can be adjusted as needed, the number and arrangement of the microphones can be freely adjusted accordingly. It not only can enhance the adaptability of the three-dimensional microphone array for sound acquisition, but also ensure optimal sound acquisition performance in various acoustic environments.

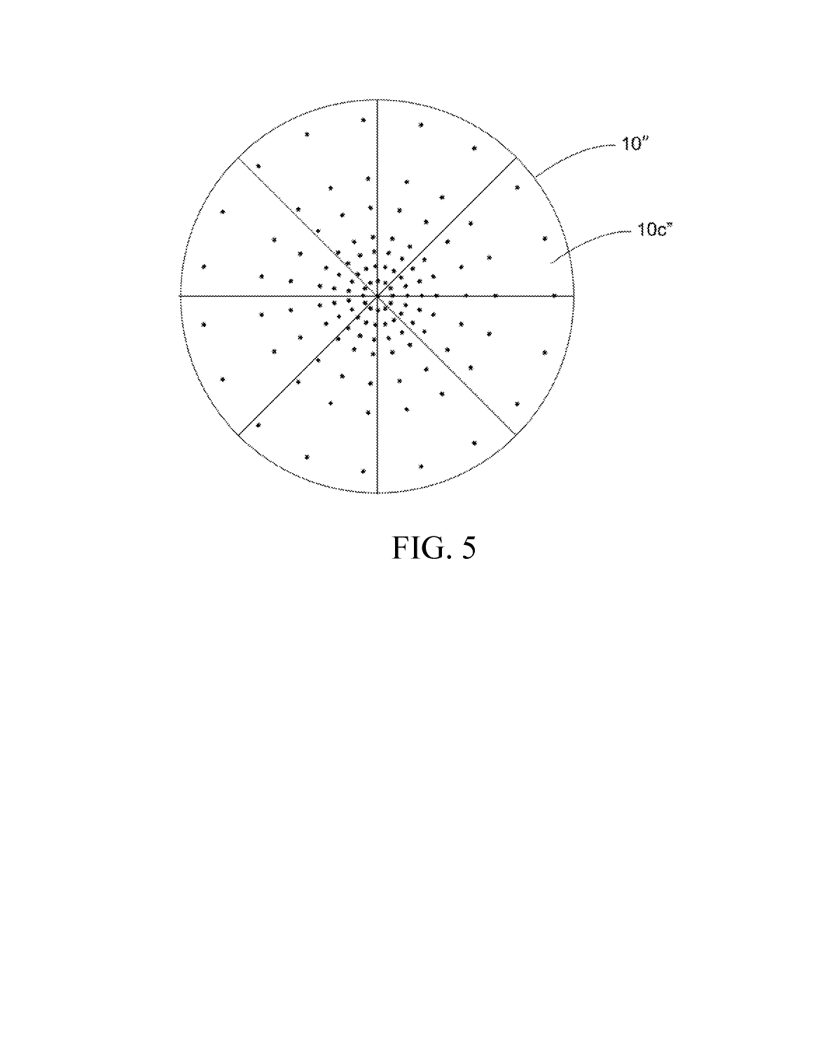

Refer to FIG. 5 which shows the three-dimensional microphone array 100 for sound acquisition according to some embodiments, the present embodiments are different from the previous embodiments in that the substrate 10" is composed of a plurality of sub-substrates pieced together. In the present embodiment, a plurality of sector-shaped sub-substrates are pieced together to form the substrate. As shown in the drawings, the substrate 10" includes a plurality of sector-shaped sub-substrates 10c". In the embodiment, taking eight sector-shaped sub- substrates 10c" as an example, the heights of each of the sector-shaped sub-substrates 10c" can be adjusted to define a height difference between the center B of the substrate and the edge C of the front surface of the substrate, thereby allowing the front surface of the substrate to have non-coplanar surfaces. The height differences between the sector-shaped sub-substrates can be freely adjusted, increasing the dynamic adjustability of the three-dimensional microphone configuration strategy and enhancing the system's adaptability.

Referring to FIG. 1 which shows the sound pickup device 100, the sound pickup device comprises at least the three-dimensional microphone array for sound acquisition according to the aforementioned embodiments. As the sound pickup device 100 utilizes the aforementioned three-dimensional microphone array, it can significantly improve the accuracy and quality of sound acquisition in three-dimensional space, especially in scenarios, such as concerts, big public speeches, and high-profile meetings, that have high requirements for sound localization, to demonstrate exceptional performances. The sound pickup device 100 of the disclosure not only can achieve precise three-dimensional localization of sound sources, but also can maintain consistency and clarity of sound acquisition in complex acoustic environments to provide users with an excellent auditory experience.

Compared to prior arts, the embodiments of the disclosure have advantages as follows.

The disclosure provides the three-dimensional microphone array for sound acquisition. The microphone array comprises a plurality of sub-microphone arrays for sound pickup, each comprising a plurality of microphones placed on the front surface of the substrate; Herein, the orthogonal projections of the plurality of microphones of each of the sub- microphone arrays onto the horizontal plane are distributed along a ray, and the ray, on which the orthogonal projections of each of the sub-microphone arrays lie, originates from the center of the orthogonal projection of the substrate onto the horizontal plane and extends to the edge of the substrate; Herein, the front surface of the substrate has a non-planar shape. Compared to prior arts, due to the non-planar front surface of the substrate, the microphone arrays provided on the substrate according to the disclosure break the planar limitation of conventional two-dimensional arrays in a simple way at a low cost, achieve a non-coplanar three-dimensional layout, and enhance precise capturing of sound sources from all directions in three-dimensional space. As the shape and number of sub-microphone arrays in the three-dimensional microphone array can be adjusted as needed, the number and arrangement of the microphones can be freely adjusted according to actual needs. It not only can enhance the adaptability of the system, but also ensure optimal sound acquisition performance in various acoustic environments.

The purposes, technical solutions and advantages of the present disclosure are described in detail in the above embodiments. It should be understood that the above particular embodiments of the disclosure are not intended to limit the present application. In particular, the present application is intended to cover all changes, equivalent arrangements and modifications included within the spirit and principle of the disclosure obtained by those skilled in the art.

What is claimed is:

1. A three-dimensional microphone array for sound acquisition, the microphone array comprising:
a substrate having a front surface and a rear surface; and
a plurality of sub-microphone arrays for sound pickup, each comprising a plurality of microphones disposed on the front surface of the substrate;
wherein orthogonal projections of the plurality of microphones of each of the sub-microphone arrays onto a horizontal plane are distributed along a ray, and the ray, on which the orthogonal projections of each of the sub-microphone arrays lie, originates from a center of an orthogonal projection of the substrate onto the horizontal plane and extends to an edge of the substrate; and
wherein the front surface of the substrate has a non-planar shape.

2. The three-dimensional microphone array for sound acquisition according to claim 1, wherein the plurality of microphones in the sub-microphone arrays are not coplanar.

3. The three-dimensional microphone array for sound acquisition according to claim 1, wherein the plurality of microphones in the sub-microphone arrays are coplanar.

4. The three-dimensional microphone array for sound acquisition according to claim 1, wherein, at least one circularly arranged sub-microphone array is further disposed at a center of the substrate, and a center of the circularly arranged sub-microphone array coincides with the center of the substrate.

5. The three-dimensional microphone array for sound acquisition according to claim 4, wherein, a straight line, on which orthogonal projections of each of the sub-microphone arrays lie, originates from the circularly arranged sub-microphone array that is farthest from the center of the substrate, and extends to an edge of the substrate.

6. The three-dimensional microphone array for sound acquisition according to claim 1, wherein the non-planar shape of the front surface of the substrate is wavy shape, and the front surface that has the wavy shape has a plurality of protruding areas arranged in sequence along a first direction.

7. The three-dimensional microphone array for sound acquisition according to claim 6, wherein the plurality of microphones in the sub-microphone arrays are disposed in sequence along a peak and a trough of the front surface that has the wavy shape.

8. The three-dimensional microphone array for sound acquisition according to claim 6, wherein the plurality of microphones of the sub-microphone arrays are disposed in sequence along a sloping surface of the front surface that has the wavy shape.

9. The three-dimensional microphone array for sound acquisition according to claim 1, wherein a center of the substrate is higher than the edge of the substrate.

10. The three-dimensional microphone array for sound acquisition according to claim 1, wherein the substrate is composed of a plurality of sub-substrates pieced together.

11. The three-dimensional microphone array for sound acquisition according to claim 10, wherein the substrate is formed by a plurality of sector-shaped sub-substrates pieced together.

12. The three-dimensional microphone array for sound acquisition according to claim 1, wherein the microphones in each of the sub-microphone arrays are arranged in a same way.

13. A sound pickup device comprising at least: the three-dimensional microphone array for sound acquisition according to claim 1.

14. The sound pickup device according to claim 13, wherein the plurality of microphones in the sub-microphone arrays are not coplanar.

15. The sound pickup device according to claim 13, wherein the plurality of microphones in the sub-microphone arrays are coplanar.

16. The sound pickup device according to claim 13, wherein, at least one circularly arranged sub-microphone array is further disposed at a center of the substrate, and a center of the circularly arranged sub-microphone array coincides with the center of the substrate.

17. The sound pickup device according to claim 16, wherein, a straight line, on which orthogonal projections of each of the sub-microphone arrays lie, originates from the circularly arranged sub-microphone array that is farthest from the center of the substrate, and extends to an edge of the substrate.

18. The sound pickup device according to claim 13, wherein the non-planar shape of the front surface of the substrate is wavy shape, and the front surface that has the wavy shape has a plurality of protruding areas arranged in sequence along a first direction.

19. The sound pickup device according to claim 18, wherein the plurality of microphones in the sub-microphone arrays are disposed in sequence along a peak and a trough of the front surface that has the wavy shape.

20. The sound pickup device according to claim 18, wherein the plurality of microphones of the sub-microphone arrays are disposed in sequence along a sloping surface of the front surface that has the wavy shape.
